(19) United States
(12) Patent Application Publication
(10) Pub. No.: US 2024/0421592 A1
(43) Pub. Date: Dec. 19, 2024

(54) Hot Swappable Monoblock Battery

(71) Applicant: Textron Aviation Inc., Wichita, KS (US)

(72) Inventors: Kyle Dietz Tidball, Wichita, KS (US); Russell Allan Sharp, Wichita, KS (US); Vernon Weng-Yew Chang, Wichita, KS (US); Michael Louis Koonce, Wichita, KS (US)

(21) Appl. No.: 18/745,643

(22) Filed: Jun. 17, 2024

Related U.S. Application Data
(60) Provisional application No. 63/508,379, filed on Jun. 15, 2023.

(51) Int. Cl. H02J 1/00; B64D 47/00; H01M 10/42; H01M 50/204; H01M 50/258; H02J 1/08

(52) U.S. Cl. CPC H02J 1/001; B64D 47/00; H01M 10/425; H01M 50/204; H01M 50/258; H02J 1/084; B64D 2221/00; H01M 2010/4278; H01M 2220/20

(57) ABSTRACT

A battery module includes a monoblock comprising one or more battery cells, a first power path electrically coupled to the monoblock and electrically couplable to one or more terminals, a switching device coupled to the first power path and configured to open and to close a circuit thereof, a control system that controls the switching device, and a second power path electrically coupled to the monoblock. The second power path is configured to provide power to the control system. An absence of a voltage signal from the second power path detected by the control system causes the switching device to open to electrically disconnect the one or more terminals of the first power path. Detection of the voltage signal from the second power path by the control system may cause the switching device to close to electrically connect the one or more terminals of the first power path.

### CROSS-REFERENCE TO RELATED APPLICATION

This application claims the benefit of priority of U.S. Provisional Patent Application No. 63/508,379, entitled “Hot Swappable Monoblock Aircraft Battery”, and filed on Jun. 15, 2023, the disclosure of which is herein incorporated by reference in its entirety.

### BACKGROUND

### Field

Embodiments of the invention relate generally to battery modules, and more specifically to a hot-swappable battery unit for providing power to an aircraft.

### Related Art

Various solutions have been proposed for connecting battery modules to an electrical system of an aircraft. For example, U.S. Pat. No. 10,974,843 of Chang et al. discloses auxiliary power units for use in an aircraft that include one or more battery modules having bi-stable relays, and a plurality of hot-swappable racks distributed throughout the aircraft for receiving the one or more battery modules. U.S. Pat. Nos. 9,583,794 and 10,027,133 to Adrian et al. disclose a modular battery system having a plurality of battery sub-modules operably connected in parallel, and isolation and condition systems configured to isolate any one battery sub-module from the remaining battery sub-modules such that battery sub-modules can be individually added, removed, isolated and/or conditioned while other battery sub-modules continue to provide power. International Application Reference No. WO2018222546 and U.S. Pat. No. 10,903,464 to Huff disclose a multi-modular battery system having interchangeable individual battery modules that can be replaced and that communicate with each other using optical communication methods. Each battery module includes a plurality of cells. U.S. Patent Application Reference No. 2021/0203015 to Ahrens et al. discloses a modular battery device with one or more replaceable cell elements that are removable from the device without uninstalling the device or disrupting a power supply from the other cell elements in the device.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a battery module that includes a monoblock including one or more battery cells is provided. The battery module includes a first power path electrically coupled to the monoblock and configured to form a first circuit that is electrically couplable to one or more battery module terminals, a solid-state relay printed circuit board (SSR PCB) that includes a switching device coupled to the first power path and configured to open and to close the first circuit thereof, a control system that controls the switching device of the SSR PCB, and a second power path electrically coupled to the monoblock and configured to form a second circuit and to provide power to the control system. In an embodiment, a presence or absence of voltage is a voltage signal that is a control signal. When a control signal is not detected by the control system, the switching device coupled to the first power path is opened to electrically disconnect the first circuit, and thereby the one or more battery module terminals from the monoblock. When the control signal is detected by the control system, the switching device coupled to the first power path is closed to electrically connect the first circuit, and thereby the one or more battery module terminals to the monoblock.

In an embodiment, the battery module is configured to be removably couplable to a retaining structure having one or more power connector terminals. The first power path of the battery module is electrically couplable to the one or more power connector terminals of the retaining structure, and the second power path of the battery module is electrically couplable to the control system via the retaining structure.

In an embodiment, uncoupling the battery module from the retaining structure electrically uncouples the control system from the retaining structure such that the control signal is not detected by the control system and the control system initiates an electrical deactivation of the first power path.

In an embodiment, coupling the battery module to the retaining structure electrically couples the second power path to the retaining structure such that the control signal is detectable by the control system to initiate and control an electrical activation of the first power path.

In an embodiment, the battery module coupled to the retaining structure is configured such that the switching device coupled to the first power path is openable to electrically uncouple the one or more power connector terminals from the monoblock whilst the second power path of the battery module is electrically coupled to the control system via the retaining structure.

In an embodiment, the retaining structure includes a monitoring system, and the second power path is configured to provide power to the control system via the monitoring system.

In an embodiment, a solid-state relay comprises the switching device.

In an embodiment, the battery module further comprises one or more signal connectors configured to communicate information regarding the battery module, wherein the one or more signal connectors include a connector electrically coupled to the second power path.

In an embodiment, the one or more signal connectors include at least one pair of voltage sense lines for measuring a voltage of the monoblock.

In an embodiment, the second power path is a current limited path that provides a limited electrical current from the monoblock.

In an embodiment, the control system includes a current sensor that communicates a current sensor signal proportional to an electrical current through the switching device to the control system to monitor a current of the battery module.

In another embodiment, a battery system is provided. The battery system includes a retaining structure for removably coupling one or more battery modules thereto and that includes one or more power connector terminals and a monitoring system, and the one or more battery modules. Each of the one or more battery modules includes a monoblock containing one or more battery cells, a high-power path electrically coupled to the monoblock and to the one or more power connector terminals of the retaining structure and to the monitoring system of the retaining structure, a switch coupled to the high-power path, a control system in communication with the switch and electrically and communicatively coupled to the monitoring system, and a low power path electrically coupled to the monoblock and to the control system via the monitoring system. The switch coupled to the high power path is openable to electrically uncouple the one or more power connector terminals when a decoupling signal is detected by the control system. The switch coupled to the high-power path is closable to electrically couple the one or more power connector terminals when a coupling signal is detected by the control system.

In an embodiment, the decoupling signal is an absence of a voltage signal, and the coupling signal is a presence of a voltage signal.

In an embodiment, the control system of the one or more battery modules detects the decoupling signal when the one or more battery modules are removed from the retaining structure.

In an embodiment, coupling each of the one or more battery modules to the retaining structure electrically and communicatively couples the control system to the monitoring system of the retaining structure such that the coupling signal is detectable by the control system to initiate and control an electrical activation of the high-power path.

In an embodiment, the low-power path enables the coupling signal to be communicated to the control system.

In yet another embodiment, a process of uncoupling a battery module from a battery system that includes one or more battery modules removably coupled to a retaining structure is provided. The process includes uncoupling the battery module from the retaining structure, transmitting a control signal from a control system to deactivate a switch coupled to a first power path of the battery module, and opening the switch coupled to the first power path to de-energize one or more battery module terminals electrically coupled thereto.

In an embodiment, the process further comprises communicating a status of the battery module via a signal connector that includes a connector electrically connectable to a second power path of the battery module.

In an embodiment, a solid-state relay comprises the switch that enables the control signal from of the control system to engage a switching function of the switch coupled to the first power path.

In an embodiment, the process further comprises sensing a sequence of disconnections of two or more connectors of the battery module, wherein one of the two or more connectors includes a last make/first break connection.

### BRIEF DESCRIPTION OF THE DRAWING FIGURES

Embodiments of the invention are described in detail below with reference to the attached drawing figures, wherein:

FIG. 1 shows a perspective view of an embodiment of a hot-swappable battery system that includes three battery modules coupled to a retaining structure;

FIG. 2 shows a schematic representation of the embodiment of the battery system in FIG. 1 that includes a battery module communicatively and electrically coupled to a monitoring system in the retaining structure;

FIG. 3 shows an exploded perspective view of the embodiment of the battery system in FIG. 1 that includes the three battery modules dismounted from the retaining structure, and each battery module includes control electronics, including a control system and a relay, configured to be coupled to the monitoring system of the retaining structure, the retaining structure is transparent to show the bus system that is between the battery modules and the monitoring system and to which terminals of the battery modules engage;

FIG. 4 shows a perspective view of an alternate embodiment of a hot-swappable battery system;

FIG. 5 shows a rotated, exploded perspective view of the embodiment of the battery system in FIG. 4 that includes three battery modules, an electrical bus system, a fastening device, and a retaining structure that includes a monitoring system coupled to an interior of a terminal wall of the retaining structure; and

FIG. 6 shows a block diagram representing an embodiment of an exemplary process of hot swappably uncoupling the battery module from the battery system shown in FIGS. 1 and 4.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

As used herein, the term monoblock or battery monoblock generally refers to a configuration of cells electrically coupled together to form a single (i.e. mono) block. The term battery module refers to a collection of battery cells, which may be in the form of a monoblock, coupled to electronic components, such as a control system. In an embodiment, the battery module includes a monoblock containing one or more battery cells, and the monoblock may be removably coupled to electronic components.

As used herein, deactivated can mean that the electronics are not powered or that the electricity conducting terminals and pins are de-energized or uncoupled or isolated from an electrical circuit whereby no electrical current flow is possible. Similarly, activated can mean that the electronics are powered or that the electricity conducting terminals and pins are energized or coupled or connected to an electrical circuit whereby electrical current flow is possible.

A battery module having a battery monoblock that comprises one or more battery cells, such as rechargeable lithium-ion battery cells or electrochemical cells, may be connected to and provide electrical power for distribution through an electrical power distribution system of an aircraft (not shown) to provide power to one or more aircraft systems. U.S. patent application Ser. No. 18/638,428 to Henderson et al. incorporated herein in its entirety by reference describes a battery module system configured to contain one or more monoblocks that may be used in an aircraft. Hot swappable battery modules enable a number of the battery modules to be selectively reduced or increased, such as, for example, to decrease a weight and/or to increase an electrical capacity provided to the aircraft systems, in an efficient process that does not include powering off the aircraft systems prior to mounting or dismounting the battery module. A hot-swappable auxiliary power unit (“APU”), as described in U.S. Pat. No. 10,974,843 to Chang et al., incorporated herein in its entirety by reference, includes a battery module and a rack that provides for the battery module to be electrically connected to or disconnected from the power distribution system without powering down the electrical system that is being powered by the battery module, or powering down the battery module prior to connecting or disconnecting the battery module, thus not interrupting a normal operation of the electrical system. This battery module incorporates a bi-stable relay that maintains either a closed switch mode or an open switch mode when the battery module is dismounted and pins/sockets for signal communication to provide a last-mate connection when connecting the battery module to the rack and a first-break connection when disconnecting the battery module from the rack.

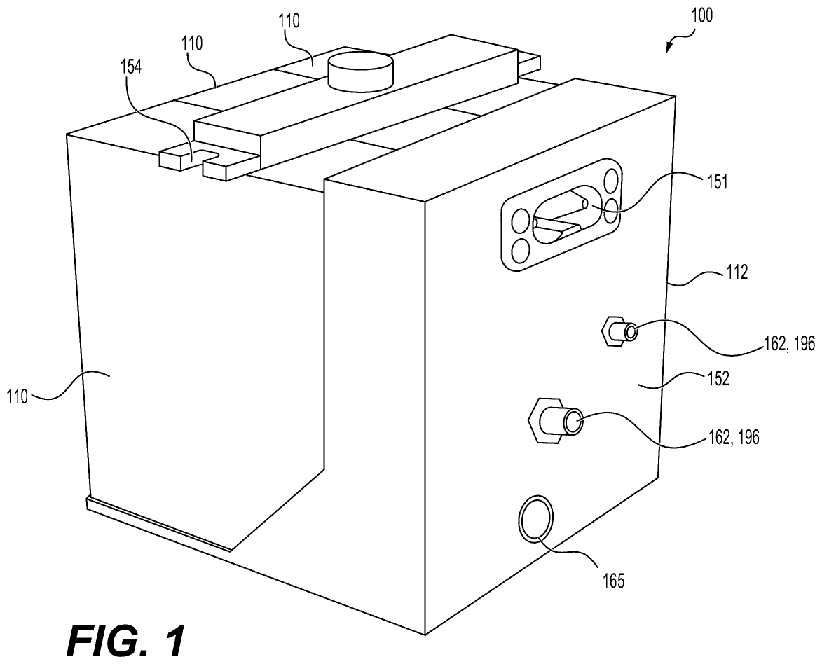

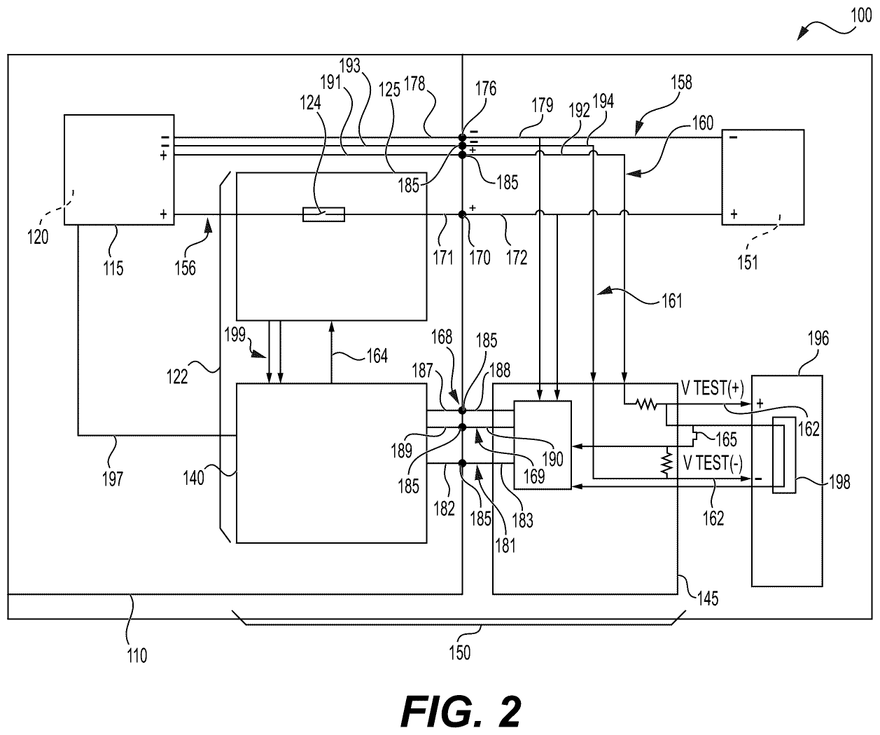

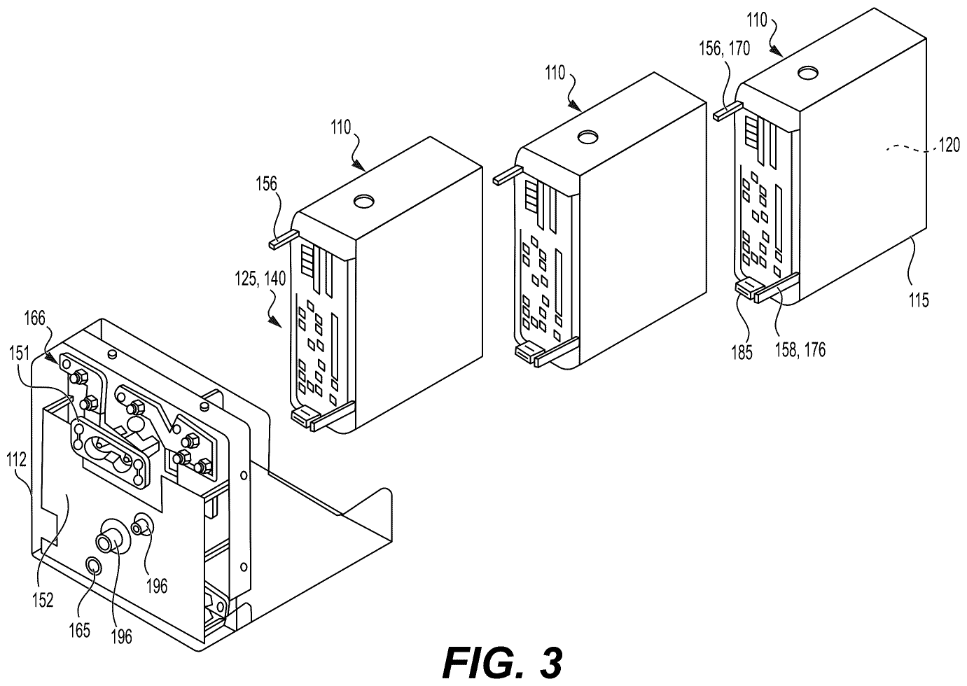

In an embodiment described herein, a hot-swappable battery system or unit 100 comprises one or more battery modules 110 and a retaining structure or chassis 112. As shown in FIG. 1, the chassis 112 contains three battery modules 110, and as shown in FIG. 2, each battery module 110 comprises a monoblock 115 having one or more battery cells 120 and control electronics 122 that include an electronic switch or relay 124 actuatable by a solid-state relay printed circuit board (“SSR PCB”) 125 controlled by a control system 140, such as a control system printed circuit board. The SSR PCB 125 includes the electronic switching device 124 that is configured to turn on or off the power being supplied to terminals of the battery module 110 or to terminals connectable to the aircraft. In one embodiment, the switch 124 is a mechanical switch controlled by the control system 140. In an embodiment shown in FIG. 3, the battery modules 110 each include the control electronics 122 that comprise the SSR PCB 125 and the control system 140, and the control electronics 122 are removably coupled to the monoblock 115. Although three battery modules 110 are shown in FIG. 1, fewer or greater than three battery modules 110 may be used in the hot-swappable battery system 100 without departing from the scope of the invention described herein. Each battery module 110 is configured to be removably mounted to the retaining structure 112 and electrically and communicatively connected to a monitoring system 145 that is coupled to the retaining structure 112. Each battery module 110 is hot-swappable and a connection between the battery monoblock 115 and the electrical power distribution system of the aircraft is controlled by a monoblock powered circuitry system 150 that includes the SSR PCB 125 comprising the electronic switch 124, the control system 140, and the monitoring system 145.

Internal battery software of the monoblock powered circuitry system 150 controls the connection of the battery module 110 to the aircraft, in contrast to the prior art in which the aircraft initiated a connection between the battery and the aircraft. The battery software is programmed to recognize when the battery module 110 is dismounted or physically removed from the retaining structure 112 and, upon such recognition, is configured to electrically deactivate one or more terminals of the battery module 110 as described herein to prevent potential risks associated with the terminals remaining live. The battery software may also be programmed to recognize when the battery module 110 is mounted onto the retaining structure 112 and, upon such recognition, is configured to activate the terminals of the battery module 110 to electrically connect the battery module 110 to the one or more aircraft power connector terminals 151 that are configured to provide power to the electrical power distribution system of the aircraft.

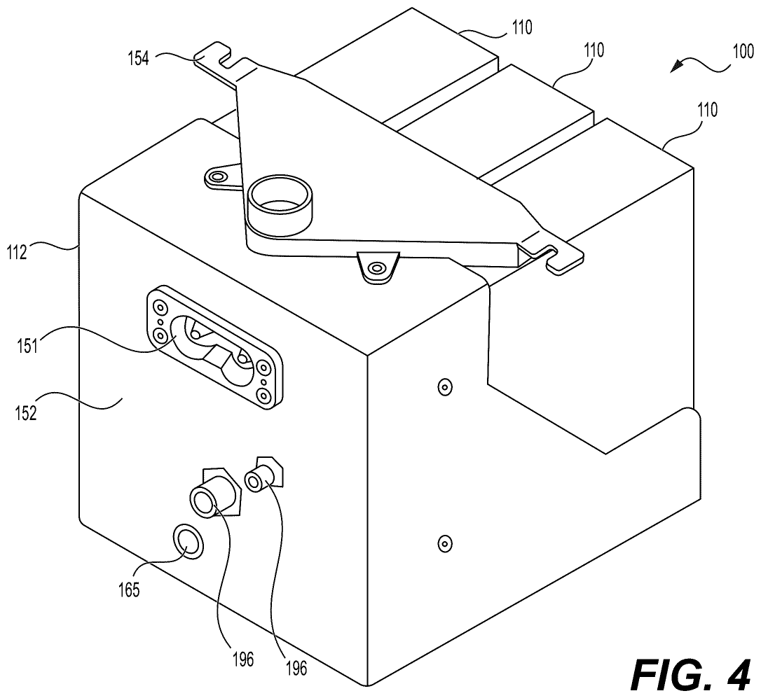

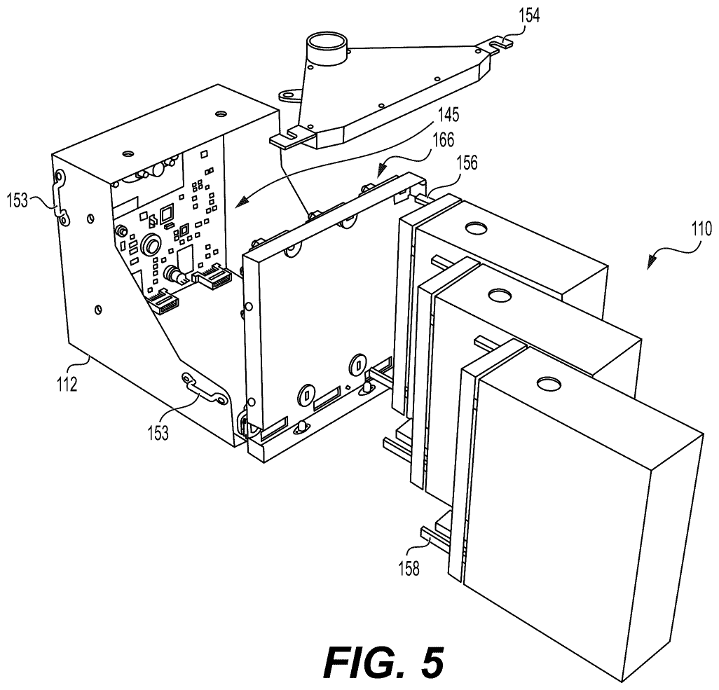

The retaining structure 112 is configured to removably retain or secure the one or more battery modules 110 therein. As shown in FIGS. 1 and 4, each battery module 110 is removably positionable in the retaining structure 112. As shown in the exploded view of the battery system 100 in FIG. 5, the battery modules 110 are mounted on or inserted into the retaining structure 112. In an embodiment, the monitoring system 145 comprising a monitoring system printed circuitry board (“PCB”) is coupled to the retaining structure 112 and may be positioned adjacent to or incorporated in or coupled to an interior of the terminal wall 152 of the retaining structure 112. In an embodiment, the retaining structure 112 is a structural support and may also provide one or more supports or handles 153 for handling the battery system 100 and/or one or more fastening devices 154 for securing the battery modules 110 in the retaining structure 112 and that may function with or be connectable to tie rods or straps to secure the battery system 100 in the aircraft. In an embodiment, the fastening device 154 is formed integral with a venting system for venting gases from and for relieving pressure within the monoblocks 115 of the one or more battery modules 110.

Each monoblock 115 includes one or more battery cells 120. In an embodiment, the monoblock 115 includes an array of 48 battery cells 120, such as, for example, six groups of battery cells 120 connected in parallel, with each group including eight battery cells 120 connected in series. Various configurations of the battery cells 120 are foreseeable and within the scope of the embodiments described herein. Each monoblock 115 may also include one or more embedded heaters (not shown) coupled to tabs or current collectors incorporated within the battery module 110 for heating the monoblock 115 which may be activated with switch 165 electrically coupled to the monoblock 115 and/or to the monoblock powered circuitry system 150.

As shown in FIG. 2, the battery monoblock 115 of each battery module 110 is electrically connected to multiple paths or circuits configured to provide electrical power to the aircraft and to the monoblock powered circuitry system 150. In an embodiment, the monoblock 115 is electrically coupled to a high-power path comprising paths 156 and 158 that provide electrical power to the aircraft via the one or more aircraft power connector terminals 151 of the retaining structure 112 and to the monoblock powered circuitry system 150. The first high power path 156 is connected to a positive terminal of the battery monoblock 115, and the high power return path 158 is connected to a negative terminal of the battery monoblock 115. A first circuit comprises the high-power path 156 and the high-power return path 158 and may be referred to herein as the first circuit or the first power path 156 and 158. In an embodiment, a presence or absence of a voltage through the high-power path 156 and 158 provides a control signal communicable through the high-power path 156 and 158 that also functions as a communication path. When the aircraft is electrically connected to the aircraft power connector terminals 151 of the battery system 100, the high-power path 156 and 158 forms the primary power delivery circuit for providing electrical power from the monoblock 115 of the battery module 110 to the electrical power distribution system of the aircraft and for discharging the battery cells 120. The high-power path 156 and 158 is also used for charging the battery cells 120.

The battery module 110 comprises the SSR PCB 125 that is coupled to the high-power path 156 between the monoblock 115 and the aircraft power connector terminals 151 such that the electronic switch 124 of the SSR PCB 125 enables the battery module 110 to be electrically connected to or disconnected from the aircraft power connector terminals 151. The SSR PCB 125 responds to the control system 140 to open or deactivate the electronic switch 124 to electrically deactivate the first circuit comprising the high-power path 156 and 158 of the battery module 110, electrically disconnecting the aircraft power connector terminals 151 from the monoblock 115, or to close or activate the electronic switch 124 to electrically activate the first circuit comprising the high-power path 156 and 158 of the battery module 110, electrically connecting the aircraft power connector terminals 151 to the monoblock 115. In an embodiment, when the SSR PCB 125 does not receive an electrical input or voltage signal 164, the switch 124 is open, and when the SSR PCB 125 receives an electrical input or voltage signal 164, the signal 164 triggers the switch 124 to close to complete the first circuit comprising the high-power path 156 and 158.

A low-power path 160 and 161 is an alternate, current-limited parallel circuit that extends from the battery monoblock 115 of each battery module 110. The low power path 160 is connected to a positive terminal of the monoblock 115, and the low power return path 161 is connected to a negative terminal of the monoblock 115. A second circuit comprises the low-power path 160 and the low-power return path 161 and may be referred to herein as the second circuit or the second power path 160 and 161. In an embodiment, a presence or absence of a voltage through the low-power path 160 and 161 provides a control signal communicable through the low-power path 160 and 161 that also functions as a communication path. The low-power path 160 and 161 is configured to provide power to the monoblock powered circuitry system 150 at least when the electronic switch 124 is opened and the first circuit comprising the high-power path 156 and 158 is deactivated as described herein. In an embodiment, when the electronic switch 124 coupled to the high-power path 156 is opened causing the first circuit formed by the high-power path 156 and 158 to be deactivated, only the low-power path 160 and 161 provides a limited electrical current of a few milliamperes or less from the monoblock 115 to power the monoblock powered circuitry system 150.

The monoblock powered circuitry system 150 has multiple functions described herein. The monoblock powered circuitry system 150 is powered by at least the low-power path 160 and 161 when the high power path 156 and 158 is deactivated. The functions of the monoblock powered circuitry system 150 include providing a means to measure a voltage of the monoblock 115, such as, for example, connectors or terminals or test pins 162 denoted in FIG. 2 by VTest (+) and VTest (−). The test pins 162 may extend to an aircraft signal connector 196 that provides a communication path from the battery system 100 to the aircraft and may be used for diagnostic purposes described herein. In an embodiment, the test pins 162 may comprise at least one pair of voltage sense lines and be directly connected to the battery monoblock 115 for measuring the voltage thereof, such as, for example, when the battery module 110 is removed from the retaining structure 112 and/or when the control electronics comprising the control system 140 and the SSR PCB 125 are removed from the battery module 110. In an embodiment, the test pins 162 may be connected to the control system 140 that is electrically connected to the monoblock 115 for measuring the voltage of the monoblock 115. The test pins 162 may also be connected via a connector to the monitoring system 145 and/or to the retaining structure 112 for measuring the voltage of the monoblock 115 of the battery module 110 and/or the battery system 100. The voltage of each monoblock 115 and/or the battery system 100 may be measured by the test pins 162 when the battery system 100 is not connected to the aircraft and/or when the battery system 100 is connected to the aircraft.

The low-power path 160 and 161 also provides electrical power to the monoblock powered circuitry system 150 to boot or initiate and control the electrical activation of the first circuit comprising the high-power path 156 and 158. In an embodiment, a user may selectively actuate a switch 165 coupled to the monitoring system 145 on the retaining structure 112 to boot or initiate and control the activation of the electrical connection of the high-power path 156 and 158 of the battery module 110. In an embodiment, the low-power path 160 and 161 automatically boots or initiates and controls the activation of the electrical connection of the high-power path 156 and 158 of the battery module 110 when the monoblock powered circuitry system 150 establishes that the battery module 110 is mounted in the retaining structure 112, as described herein. Specifically, the low-power path 160 and 161 provides power to the monoblock powered circuitry system 150 to determine whether connection criteria of the battery module 110 is met, and if the connection criteria is met the monoblock powered circuitry system 150 is able to send a control or coupling signal 164 via the control system 140 to engage the SSR PCB 125 to close the electronic switch 124 to activate the first circuit comprising the high-power path 156 and 158 from the monoblock 115 and electrically connect the monoblock 115 to the aircraft power connector terminals 151. In an embodiment, the control signal 164 is the presence of the voltage through the low-power path 160 and 161.

Still further, the low-power path 160 and 161 provides power to the monoblock powered circuitry system 150 to execute a powering down procedure when the first circuit comprising the high-power path 156 and 158 of the battery module 110 is deactivated. The powering down procedure may include collecting and saving data associated with the monoblock 115, the battery module 110, and the monitoring system 145, and/or collecting and saving data associated with the connection of the battery system 100 to the aircraft. Deactivation of the first circuit comprising the high-power path 156 and 158 of the battery module 110 may include, for example, selectively actuating the switch 165 that is configured to disable the mounted battery module 110 or an automatic deactivation of the first circuit comprising the high-power path 156 and 158 controlled by the monoblock powered circuitry system 150, such as to avoid a safety hazard.

In an embodiment, an interruption or suspension of detected voltage from the monitoring system 145 to the control system 140 signals to the control system 140 that the battery module 110 has been dismounted from the retaining structure 112. As shown in FIG. 2, the monitoring system 145 is electrically connected to and directly powered by the monoblock 115 through the high-power path 156 and 158 and/or the low-power path 160 and 161 of the battery module 110, but neither the SSR PCB 125 nor the control system 140 are directly powered by the monoblock 115. In an embodiment, the low-power path 160 and 161 provides power to a control system power path 168 and 169 that forms a control system circuit that electrically connects the control system 140 and the SSR PCB 125 to the monitoring system 145. In an embodiment, a presence or absence of a voltage through the control system power path 168 and 169 provides a control signal communicable through the control system power path 168 and 169 that also functions as a communication path. Dismounting the battery module 110 from the retaining structure 112 electrically and communicatively disconnects the power paths 156, 158, 160 and 161 extending from the monoblock 115 of the battery module 110 to the monitoring system 145 and electrically and communicatively disconnects the control system path 168 and 169 extending between the control system 140 of the battery module 110 and the monitoring system 145 of the retaining structure 112 such that the hot swappable function of the battery module 110 is enabled. In an embodiment, a control system communications path 181 extends between and enables communication between the control system 140 and the monitoring system 145 and is disconnected when the battery module 110 is disconnected from the retaining structure 112.

The low-power path 160 and 161 and the engagement of the SSR PCB 125 with the high-power path 156 and 158 enable the hot swappable function of the battery module 110. As shown in FIGS. 3 and 5, the high power path 156 and 158 engages an electrical bus system 166 of the retaining structure 112 to form the first circuit that provides electrical power from the monoblock 115 of the battery module 110 to the aircraft power connector terminals 151 and provides electrical power from the monoblock 115 to the monitoring system 145. Specifically, the high power path 156 extends from the monoblock 115 and engages a battery module terminal or connector 170 of the electrical bus system 166. The high-power path 156 includes a first high power path 171 that extends between the monoblock 115 and the terminal 170 and a second high power bus path 172 that extends between the terminal 170 and the aircraft power connector terminals 151 and the monitoring system 145. The SSR PCB 125 engages the first high power path 171. The high power return path 158 extends from the monoblock 115 and engages a battery module terminal or connector 176 of the electrical bus system 166. The high-power return path 158 includes a first high power return path 178 that extends between the monoblock 115 and the terminal 176 and a second high power return bus path 179 that extends between the terminal 176 and the aircraft power connector terminals 151 and the monitoring system 145.

The control system power path 168 and 169 and the control system communications path 181 engage a terminal or connector 185 that connects the control system 140 of the battery module 110 and the monitoring system 145. The control system power path 168 includes a first control system power path 187 that extends between the control system 140 and the terminal 185 and a second control system power path 188 that extends between the terminal 185 and the monitoring system 145. The control system power return path 169 includes a first control system power return path 189 that extends between the control system 140 and the terminal 185 and a second control system power return path 190 that extends between the terminal 185 and the monitoring system 145. The control system communications path 181 includes a first communication path 182 that extends between the control system 140 and the terminal 185 and a second communication path 183 that extends between the terminal 185 and the monitoring system 145.

In an embodiment, the low power path 160 and 161 forms the second circuit that extends from the monoblock 115 to the monitoring system 145. The low-power path 160 and 161 engages the terminal 185 that electrically and communicatively connects the battery module 110 to the monitoring system 145. The low-power path 160 includes a first low power path 191 that extends between the monoblock 115 and the terminal 185 and a second low power path 192 that extends between the terminal 185 and the monitoring system 145. The low power return path 161 includes a first low power return path 193 that extends between the monoblock 115 and the terminal 185 and a second low power return path 194 that extends between the terminal 185 and the monitoring system 145.

When the battery module 110 is mounted on and dismounted from the retaining structure 112, the terminals 170, 176, and 185 extending between the battery module 110 and the retaining structure 112 are configured to be electrical and communication connectors that provide an interface to connect and disconnect the first power and communication paths 171, 178, 182, 187, 189, 191, and 193 from the respective second power and communication paths 172, 179, 183, 188, 190, 192, and 194.

Dismounting or uncoupling of the battery module 110 from the retaining structure 112 causes the high-power path 156 and 158, the low-power path 160 and 161, and the control system power and communications paths 168, 169, and 181 to be opened or interrupted such that electrical power to the monitoring system 145 and, therefore, to the control system 140, and communications between the control system 140 and the monitoring system 145, are interrupted. The interruption or suspension of electrical power to the control system 140 automatically engages the SSR PCB 125 to open or deactivate the electronic switch 124 coupled to the high-power path 156 to electrically deactivate the first circuit comprising the high power path 156 and 158 from the monoblock 115, deenergizing the terminals 170 and 176 coupled thereto. Similarly, when the battery module 110 is coupled to or mounted in the retaining structure 112, the second circuit forming the low-power path 160 and 161 is reestablished such that the limited electrical current from the monoblock 115 powers the monoblock powered circuitry system 150, and the control system 140 engages the SSR PCB 125 to close or activate the electronic switch 124 coupled to the high-power path 156 to electrically activate the first circuit comprising the high-power path 156 and 158, as described herein.

The SSR PCB 125 includes an electronic switching device that is a coupling mechanism that enables the control signal or voltage signal or input 164 from a control circuit of the control system 140 to engage a switching function of the electronic switch 124 coupled to the high-power path 156, such as, for example, to open the electronic switch 124 automatically when the battery module 110 is dismounted, to open the electronic switch 124 when the first circuit comprising the high-power path 156 and 158 is deactivated as described herein, to close the electronic switch 124 automatically is response the battery module 110 being mounted, and/or to close the electronic switch 124 when the circuit comprising the high-power path 156 and 158 is activated as described herein. The automatic opening of the electronic switch 124 to deactivate the high-power path 156 and 158 when the battery module 110 is dismounted functions to prevent potential safety hazards, such as sparks or short circuits, that may occur if the terminals 170 and 176 of the high-power path 156 and 158 remain electrically connected to the monoblock 115 when the battery module 110 is dismounted from the retaining structure 112. Specifically, when the battery module 110 is dismounted from the retaining structure 112, the control electronics 122 that include the control system 140 and the SSR PCB 125 are electrically disconnected from the monitoring system 145 and from power supplied from the battery monoblock 115 through the high-power path 156 and 158 and/or the low-power path 160 and 161. In response, the SSR PCB 125 automatically opens the electronic switch 124 to deactivate the high-power path 156 and 158 by disconnecting the terminals 170 and 176 of the battery module 110. The control system 140 sends the control signal 164 to the SSR PCB 125 to open the electronic switch 124 coupled to the high-power path 156, and the SSR PCB 125 senses or receives the control signal 164 to open the electronic switch 124 which results in the battery monoblock 115 being electrically disconnected from the power terminals 170 and 176 thereof, turning the battery module 110 “off.” The disconnected terminals 170 and 176 of the battery module 110 are inert and no voltage is measurable across the terminals 170 and 176 of the battery module 110. As described herein, control signal 164 is the absence of a voltage signal as detected by the control system 140, and the absence of detected voltage by the control system 140 triggers the opening of the electronic switch 124 of the SSR PCB 125 to disengage the high-power path 156.

In an embodiment, a cell balancing and voltage sense path or monoblock communications path 197 provides a communication path between the control system 140 and the battery cells 120 of the monoblock 115. The monoblock communications path 197 comprises one or more voltage sensing systems and one or more charge balancing systems for measuring and balancing or equalizing voltages and states of charge of the battery cells 120 in the monoblock 115, and information from the monoblock communications path 197 is communicable with the control system 140. In an embodiment the monoblock communications path 197 may be used as a means for communicating a control signal between the monoblock 115 and the control system 140 to control the SSR PCB 125.

The monitoring system 145 includes a function to ensure that the monoblock 115 connected thereto has not had a previous fault event that may present a safety hazard. In an embodiment, the monitoring system 145 records, via the control system 140, an identification or serial number associated with each battery module 110 and/or battery monoblock 115 connected to the monitoring system 145 and fault events, such as, for example, short circuit faults, associated with each serial number. Such recordation is to prevent a monoblock 115 from being reused if a non-resettable fault occurs. The monitoring system 145 is programmable to reject a monoblock 115 having a non-resettable fault event previously recorded by the monitoring system 145 by preventing the electrical activation of the first circuit comprising the high-power path 156 and 158 of the rejected monoblock 115. In an embodiment, the monoblock 115 and/or the control system 140 are also able to store data related to fault events and communicate such data to the monitoring system 145.

The monitoring system 145 of the retaining structure 112 includes one or more aircraft signal connectors 196. Each aircraft signal connector 196 is connectable to the aircraft to communicate information or data or a status of the battery system 100 or each of the battery modules 110 and/or monoblocks 115, including when one or more of the battery modules 110 are dismounted. As shown in FIG. 2, a connector jumper 198 of the aircraft signal connector 196 is electrically connected in series with the low-power path 160. When the low-power path 160 and 161 from the monoblock 115 is disconnected from the aircraft signal connector 196, i.e., the battery module 110 is dismounted, the absence of the voltage signal, and therefore the battery module 110 is communicated to the aircraft. In an embodiment, the aircraft signal connector 196 comprises the connectors or test pins 162 for measuring a voltage of the monoblock 115 and functions to communicate information from the battery system 100 to the aircraft for diagnostic purposes, including, for example, which battery modules 110 and/or monoblocks 115 are mounted thereto, a state of charge of each monoblock 115, the measured voltage of each monoblock 115, and fault events recorded by the monitoring system 145.

The control system 140 comprises a control PCB that is electrically and communicatively connected between the SSR PCB 125 and the monitoring system 145. As described herein, the control system 140 is programmed to control the control circuit that transmits the control signal 164 to control the electronic switch 124 of the SSR PCB 125 that is coupled to the high-power path 156 depending on a signal and/or an absence or presence of a voltage signal from the monitoring system 145.

In an embodiment, the control system 140 comprises a current sensor 199 that forms a current sensor circuit that transmits information that includes a voltage signal, which is proportional to the current through the SSR PCB 125, from a shunt embedded within the SSR to the control system 140. This information is used to monitor for abnormal current conditions, such as, for example, a short circuit in either direction (into or out of the monoblock 115), and for calculating, for example, a state of charge of the monoblock 115, etc., to be communicated to the monitoring system 145. Detection of abnormal current conditions may be communicated to the control system 140 and/or monitoring system 145 which may subsequently engage the control system 140 to send the control signal 164 to open the electronic switch 124 to deactivate the first circuit comprising the high-power path 156 and 158 of battery module 110, resulting in deactivation of the aircraft power connector terminals 151. The information from the current sensor 199 may also be used by the monoblock powered circuitry system 150 for calculating the state of charge of the monoblock 115, and such information and/or calculated data may be communicated to the aircraft for monitoring.

In an embodiment, the control system 140 is able to sense and determine from a sequence of connections or disconnections of at least the connectors 170, 176, and 185 whether the battery module 110 is being dismounted from the retaining structure 112 or mounted on the retaining structure 112. A last make/first break (“LMFB”) connection may be utilized by the monoblock powered circuitry system 150 to determine when the battery module 110 is being dismounted from or mounted on the retaining structure 112. When the battery module 110 is dismounted from the retaining structure 112, the connector 185 is disconnected prior to the high-power connectors 170 and 176 being disconnected, and upon mounting, the connectors 170 and 176 are connected first, and the connector 185 is subsequently connected. For connector 185 this can be referred to as the LMFB connection. The LMFB connection of connector 185 enables the control system 140 and/or the monitoring system 145 to determine that the battery module 110 is being mounted to automatically start initiation of the activation of the electrical connection of the high-power path 156 and 158 from the monoblock 115 to the aircraft power connector terminals 151 and the monoblock powered circuitry system 150, described herein. In addition, the LMFB connection of connector 185 enables the control system 140 and/or the monitoring system 145 to determine that the battery module 110 is being dismounted to automatically engage the control system 140 to transmit the control signal 164 of the control circuit to open the electronic switch 124 of the SSR PCB 125 to electrically disconnect the terminals 170 and 176 of the battery module 110 and/or start the execution of a powering down procedure of the battery module 110.

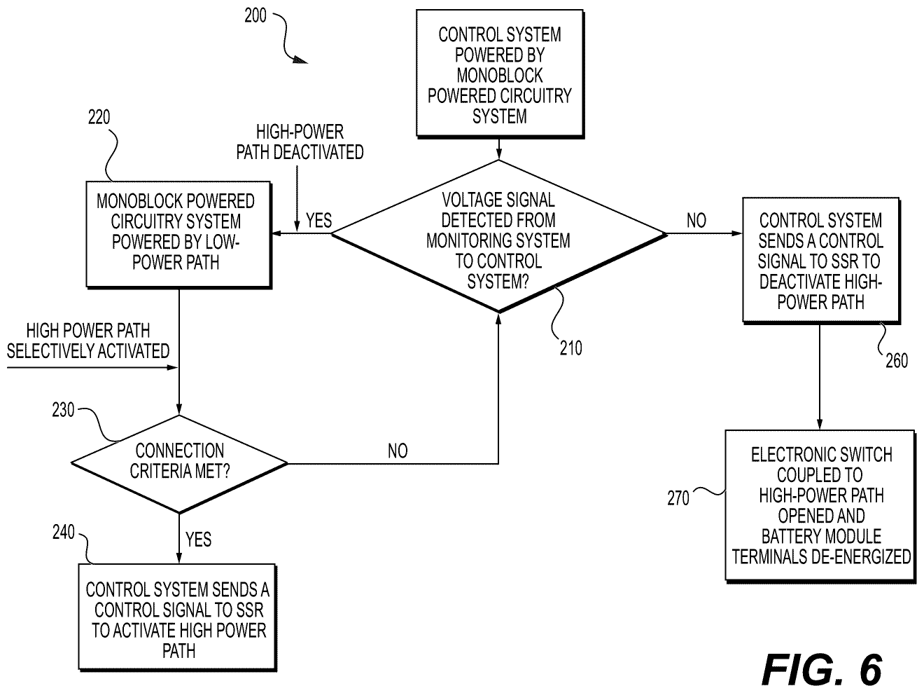

A flowchart of a hot swappable dismount process 200 of the battery module 110 from the battery system 100 is shown in FIG. 6. The process 200 begins with the battery module 110 removably coupled or retained in the retaining structure 112 and the circuit formed by the high-power path 156 and 158 of the battery module 110 electrically connected to the aircraft power connector terminals 151 of the retaining structure 112 that are configured to provide power to the aircraft. The circuit of the high-power path 156 and 158 and/or the low-power path 160 and 161 also provide power to the monoblock powered circuitry system 150 that includes the monitoring system 145 coupled to the retaining structure 112 and the control system 140 and SSR PCB 125 of the battery module 110. A voltage signal that is detected by the control system 140 signifies that the battery module 110 remains mounted in the retaining structure 112, at step 210. The electronic switch 124 may be selectively or automatically opened to electrically deactivate the first circuit comprising the high-power path 156 while the low-power path 160 and 161 provides a limited electrical current of a few milliamperes or less from the monoblock 115 to power the monoblock powered circuitry system 150, at process step 220. The circuit formed by the high-power path 156 and 158 may be selectively reactivated to electrically connect the aircraft power connector terminals 151 to the monoblock 115, such as, for example, by a user actuating the switch 165 coupled to the monitoring system 145. When the circuit comprising the high-power path 156 and 158 is selectively activated, the low-power path 160 and 161 initiates and controls the activation of the electrical connection of the high-power path 156 and 158 of the battery module 110. If connection criteria is met, the monoblock powered circuitry system 150 sends the control signal 164 to engage the SSR PCB 125 to close the electronic switch 124 to activate the circuit comprising the high-power path 156 and 158 to electrically connect the monoblock 115 to the aircraft power connector terminals 151, at step 240.

In the case that the battery module 110 is dismounted, the circuit comprising the low power path 160 and 161 is electrically deactivated and the voltage signal through the control system path 168 and 169 to the control system 140 is stopped or suspended. The control system 140 detects that the battery module 110 is being dismounted by an absence of the voltage signal to the control system 140. At step 260, the control system 140 sends the control signal 164 to engage the SSR PCB 125 to open the electronic switch 124 coupled to the high-power path 156 to electrically deactivate the circuit thereof. At step 270, the circuit forming the high-power path 156 and 158 is electrically deactivated and the terminals 170 and 176 are electrically disconnected from the monoblock 115 and inert or de-energized to prevent a spark and/or a short circuit in the dismounted battery module 110.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A battery module comprising:
a monoblock comprising one or more battery cells;
a first power path electrically coupled to the monoblock, the first power path configured to form a first circuit that is electrically couplable to one or more battery module terminals;
a switching device coupled to the first power path and configured to open and to close the first circuit thereof;
a control system that controls the switching device;
a second power path electrically coupled to the monoblock, the second power path configured to form a second circuit and to provide power to the control system; wherein:
when a control signal is not detected by the control system, the switching device coupled to the first power path is opened to electrically disconnect the one or more battery module terminals, and
when the control signal is detected by the control system, the switching device coupled to the first power path is closed to electrically connect the one or more battery module terminals.

2. The battery module of claim 1, wherein the battery module is configured to be removably couplable to a retaining structure having one or more power connector terminals, the first power path of the battery module is electrically couplable to the one or more power connector terminals of the retaining structure, and the second power path of the battery module is electrically couplable to the control system via the retaining structure.

3. The battery module of claim 2, wherein uncoupling the battery module from the retaining structure electrically uncouples the control system from the retaining structure such that the control signal is not detected by the control system and the control system initiates an electrical deactivation of the first power path.

4. The battery module of claim 2, wherein coupling the battery module to the retaining structure electrically couples the second power path to the retaining structure such that the control signal is detectable by the control system to initiate and control an electrical activation of the first power path.

5. The battery module of claim 2, wherein the battery module coupled to the retaining structure is configured such that the switching device coupled to the first power path is openable to electrically uncouple the one or more power connector terminals from the monoblock whilst the second power path of the battery module is electrically coupled to the control system via the retaining structure.

6. The battery module of claim 2, wherein the retaining structure includes a monitoring system, and the second power path is configured to provide power to the control system via the monitoring system.

7. The battery module of claim 1, wherein a solid-state relay comprises the switching device.

8. The battery module of claim 1, further comprising one or more signal connectors configured to communicate information regarding the battery module, wherein the one or more signal connectors include a connector electrically coupled to the second power path.

9. The battery module of claim 8, wherein the one or more signal connectors comprise at least one pair of voltage sense lines for measuring a voltage of the monoblock.

10. The battery module of claim 1, wherein the second power path is a current limited path that provides a limited electrical current from the monoblock.

11. The battery module of claim 1, wherein the control system comprises a current sensor that communicates a current sensor signal proportional to an electrical current through the switching device to the control system to monitor a current of the battery module.

12. A battery system comprising:
a retaining structure for removably coupling one or more battery modules thereto, the retaining structure including one or more power connector terminals and a monitoring system; and
the one or more battery modules, wherein each of the one or more battery modules comprises:
a monoblock containing one or more battery cells;
a high-power path electrically coupled to the monoblock and to the one or more power connector terminals of the retaining structure and to the monitoring system of the retaining structure;
a switch coupled to the high-power path;
a control system in communication with the switch and electrically and communicatively coupled to the monitoring system; and
a low power path electrically coupled to the monoblock and to the control system via the monitoring system; wherein:
the switch coupled to the high-power path is openable to electrically uncouple the one or more power connector terminals when a decoupling signal is detected by the control system, and
the switch coupled to the high-power path is closable to electrically couple the one or more power connector terminals when a coupling signal is detected by the control system.

13. The battery system of claim 12, wherein the decoupling signal is an absence of a voltage signal, and the coupling signal is a presence of a voltage signal.

14. The battery system of claim 12, wherein the control system of the one or more battery modules detects the decoupling signal when the one or more battery modules are removed from the retaining structure.

15. The battery system of claim 12, wherein coupling each of the one or more battery modules to the retaining structure electrically and communicatively couples the control system to the monitoring system of the retaining structure such that the coupling signal is detectable by the control system to initiate and control an electrical activation of the high-power path.

16. The battery system of claim 15, wherein the low power path enables the coupling signal to be communicated to the control system.

17. A process of uncoupling a battery module from a battery system, the battery system including one or more battery modules removably coupled to a retaining structure, the process comprising:
uncoupling the battery module from the retaining structure;
transmitting a control signal from a control system to deactivate a switch coupled to a first power path of the battery module; and
opening the switch coupled to the first power path to de-energize one or more battery module terminals electrically coupled thereto.

18. The process of claim 17, further comprising communicating a status of the battery module via a signal connector that includes a connector electrically connectable to a second power path of the battery module.

19. The process of claim 17, wherein a solid-state relay comprises the switch that enables the control signal from of the control system to engage a switching function of the switch coupled to the first power path.

20. The process of claim 17, further comprising sensing a sequence of disconnections of two or more connectors of the battery module, wherein one of the two or more connectors includes a last make/first break connection.
